(19) United States
(12) Patent Application Publication
(10) Pub. No.: US 2013/0078451 A1
(43) Pub. Date: Mar. 28, 2013

(54) NANO-PARTICLE COATED GENUINE LEATHER FLOOR

(71) Applicant: Ruofei ZHANG, Shanghai (CN)

(72) Inventor: Ruofei ZHANG, Shanghai (CN)

(21) Appl. No.: 13/239,433

(22) Filed: Sep. 22, 2011

(51) Int. Cl. B32B 5/16; B32B 9/02; B82Y 30/00

(52) U.S. Cl. 428/328; 428/446; 977/902; 977/700

(57) ABSTRACT

A nano-particle coated genuine leather floor including genuine leather, a leather pigment, and nano-powder. The nano-powder is a mixture of nano-silver and sub-nanometer SiO₂ with a weight ratio of 1:33 to 1:5. The nano-powder is added into the leather pigment and the resulting mixture is coated on genuine leather. The nano-particle coated genuine leather floor has high degree of wear resistance, moisture resistance, good antibacterial property, and long service lifetime.

### BACKGROUND OF THE INVENTION

Field of the Invention

The invention relates to a building material, and more particularly to a nano-particle coated genuine leather floor.

Description of the Related Art

Generally, genuine leather is obtained and made by processing original skins of cattle, sheep, pigs, crocodiles, and other animals into various leather materials, and then spraying chemical material or covering polyvinyl chloride (PVC) and polyurethane (PU) films. It is used in the fields of textiles and decoration. Genuine leather floors, with high quality leather as raw materials and made by means of vegetable tanning, have a beautiful surface, brilliant color, natural gloss, soft touch, and unique style. They are wear resistant, anti-absorbent, easy-to-clean, non-flammable, waterproof, soundproof, and thermally-insulating. Conventional leather floors are mainly composed of wood support plates, on which elastic materials are applied and then the elastic materials covered with genuine leather. On some genuine leather floors, nails are used to fix around the wood support plates that cover the leather surfaces. According to user needs, the genuine leather floor can be made to have various colors or patterns. Since genuine leather is soft, paint free and the elastic material shows remarkable shock absorption and soundproof effects, it is not only comfortable but favorable to environmental protection and human health. Compared with carpets, it does not easily hide dust and is easy to clean.

However, disadvantages of conventional genuine leather floors include insufficient wear resistance, low moisture resistance, poor antibacterial property, and short service life.

### SUMMARY OF THE INVENTION

In view of the above-described problems, it is one objective of the invention to provide a nano-particle coated genuine leather floor with high degree of wear resistance, moisture resistance, good antibacterial property, and long service life.

To achieve the above objectives, in accordance with one embodiment of the invention, there is provided a nano-particle coated genuine leather floor comprising genuine leather, a leather pigment, and a nano-powder, wherein the nano-powder is a mixture of nano-silver and sub-nanometer SiO₂ with a weight ratio of 1:33 to 1:5; and the floor is produced using a method comprising adding the nano-powder into the leather pigment to yield a mixture and coating the mixture on the genuine leather.

In a class of this embodiment, the nano-silver is a layered structure with both a thickness and a width of 50-200 nm and a length of 1-5 μm. The sub-nanometer SiO₂ is a spherical structure with a particle size of 0.5-10 μm.

The nano-powder prepared according to a certain ratio is added into the leather pigment, and the resulting mixture is treated using post-treatment process and coated on the genuine leather using traditional processes. The nano-particle coated genuine leather floor comprises three layers: the first layer comprises nano leather; the second layer is PVC or rubber material or something like that (through specific complex covering); the third layer comprises felt cloth for cushioning and decoration and hook & loop for fixation.

Nanomaterials have various advantages such as lightweight, high toughness, extremely strong moisture absorption capacity, antibacterial property, and flame retardancy. Therefore, the introduction of nanotechnology will necessarily bring vitality to the leather industry. Currently, common nano ions, for example, nano-silver ions with antibacterial effect, can be put into trial use of retanning process. Common functional leather is mainly obtained by means of painting, which will destroy excellent physical properties of leather. The difficult problem is expected to be solved by using nano retanning agents. With proper use of nanomaterials, the product will produce great eco-friendly effects.

Adding new nano materials into the surface pigment of genuine leather makes the leather has high antibacterial property. When nano-silver particles directly enter into bacteria, they would combine with oxygen therein through metabolism (—SH), thereby leading to suffocation and death of most of the bacteria, fungi, mold, and spores. Studies show that nano-silver has excellent antibacterial activity for drug-resistant pathogens, for example, drug-resistant E. coli, drug-resistant Staphylococcus aureus, Pseudomonas aeruginosa, Streptococcus pyogenes, enterococci, and anaerobic bacteria. It also has bactericidal effects on common bacteria such as Staphylococcus aureus, Escherichia coli, Pseudomonas aeruginosa, Candida albicans and other G+ and G− pathogens, which are frequently seen on the surfaces of burns and trauma. A type of antibiotic can kill about six types of pathogens while nano-silver can kill hundreds of pathogenic microorganisms. Nano-silver particles are produced with patented technology and have an external protection film, which is gradually released when human body contacts with other objects. Therefore, it shows a durable antibacterial effect. Meanwhile, when sub-nanometer SiO₂ is added to the leather surface pigment, it greatly improves wear resistance of the leather layer with superior stability, reinforcing ability, thickening property, and thixotropy. It also greatly improves wear resistance of the leather surface and prolongs the service life without damaging physical properties of the nano leather surface.

Nano-leather technology is the one used to form new substances and develop new applications within nano scope. Nanomaterials for the genuine leather used in the invention mainly comprise nano-silver and sub-nanometer SiO₂.

Nano-silver uses cutting-edge nanotechnology for nano crystallization of silver and thus make silver possess extraordinary bactericidal ability. A very little of nano-silver can generate strong sterilization effects and kill 650 kinds of bacteria within minutes. Furthermore, nano-silver particles have superior permeability.

Sub-nanometer SiO₂ is a very important high-tech and new ultra-fine inorganic material. Due to very small particle diameter, large specific surface area, strong surface adsorbability, and high surface energy, it shows specific performance in terms of high chemical purity, excellent dispersion performance, thermal resistance, and resistivity. Compared with conventional materials, sub-nanometer SiO₂ shows unique functions in terms of magnetic property, catalytic activity, optical absorption, thermal resistance, and melting point, so it attracts extremely great attention from people. It is widely used in many such fields as rubber, plastics, electronics, paint, ceramics (enamel), plaster, batteries, paints, adhesives, cosmetics, glass, steel, fiber, organic glass, and environmental protection.

Studies have shown that sub-nanometer SiO₂ has following effects when it is used for the pigment (dye). Though organic pigment (dye) has bright color and strong color strength, its resistance to light, heat, solvent and migration is generally less than that of inorganic pigment. When conducting surface modification to organic pigment (dye) by adding nano SiO₂, it not only substantially improves anti-aging property of pigment (dye), but also improves brightness, hue, and saturation degree to some extent. Its performance can be comparable to imported high-end products and it greatly broadens grade and applicable range of the organic pigment (dye).

When the sub-nanometer SiO₂ is used for synthetic coating, it has the following effects: this type of nano synthetic coating has avoided the disadvantages of previous products and its main performance indices are significantly improved after the examination except the contrast ratio. For example, if it is applied for external wall painting, it will improve the scrub resistance of the external wall from previous 1000 times to more than 10000 times. In addition, bonding strength between the coating films and the wall has been greatly improved, so do the hardness of the coating films and self-cleaning ability.

According to the above description, the invention makes nano-powders be evenly mixed in the pigment of the leather surface layer through adding nano-powder, which is prepared according to a specific ratio, into the leather surface pigment. After post-treatment process, the final product is obtained, which is a type of nano-particle coated genuine leather floor with high wearproof degree, excellent moisture resistance, antibacterial property, and long service life.

### DETAILED DESCRIPTION OF THE EMBODIMENTS

For further illustrating the invention, experiments detailing a nano-particle coated genuine leather floor are described below. It should be noted that the following examples are intended to describe and not to limit the invention.

The invention is achieved as follows: a nano-powder is added into a genuine leather pigment; the nano-powder is a mixture of nano-silver and sub-nanometer SiO₂with a weight ratio of 1:33 to 1:5. The nano-silver has a layered structure with both a thickness and a width of 50-200 nm and a length of 1-5 μm while sub-nanometer SiO₂ has a spherical structure with particle size range of 0.5-10 μm. The nano-powder, which is prepared according to a specific ratio, is added into the leather pigment. The resulting mixture is treated using post-treatment process and coated on the genuine leather using traditional processes.

Adding new nano material into the genuine leather surface pigment makes the leather has high antibacterial property. When nano-silver particles directly enter into bacteria, they would combine with oxygen therein through metabolism (—SH), thereby leading to suffocation and death of most of the bacteria, fungi, mold, and spores. Meanwhile, when sub-nanometer SiO₂ is added to the leather surface pigment, it greatly improves wear resistance of the leather layer with superior stability, reinforcing ability, thickening property, and thixotropy. It also greatly improves wear resistance of the leather surface and prolongs service life without damaging physical properties of the nano leather surface.

Nano-silver uses cutting-edge nanotechnology for nano crystallization of silver and make silver possesses extraordinary antibacterial ability. A very little of nano-silver can generate strong bactericidal effects and kill 650 kinds of bacteria within minutes and nano-silver particles provide superior permeability.

Studies have shown that sub-nanometer SiO₂ has following effects when used for the pigment (dye). Though organic pigment (dye) has bright color and strong color strength, its resistance to light, heat, solvent, and migration is generally less than that of inorganic pigment. When conducting surface modification to organic pigment (dye) by adding nano SiO₂, it not only substantially improves anti-aging property of pigment (dye), but also improves indices of brightness, hue and saturation degree to some extent. Its performance can be comparable to imported high-end products and it greatly broadens grade and applicable range of the organic pigment (dye).

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A floor material, comprising:
a) genuine leather,
b) a leather pigment, and
c) a nano-powder, wherein
said nano-powder is a mixture of nano-silver and sub-nanometer SiO₂ with a weight ratio of 1:33 to 1:5; and
said floor material is produced using a method comprising adding said nano-powder into said leather pigment to yield a mixture and coating said mixture on the genuine leather.

2. The floor material of claim 1, wherein said nano-silver is a layered structure with both a thickness and a width of 50-200 nm and a length of 1-5 μm, and said sub-nanometer SiO₂ is a spherical structure with a particle size of 0.5-10 μm.
